(19) United States
(12) Patent Application Publication
(10) Pub. No.: US 2014/0195330 A1
(43) Pub. Date: Jul. 10, 2014

(54) METHODS AND APPARATUS FOR PROVIDING EFFECTIVENESS SCORE OF ADVERTISEMENTS

(71) Applicant: Tremor Video, Inc., New York, NY (US)

(72) Inventors: Steven Lee, Arlington, MA (US); Kelly Lauren McEttrick, New York, NY (US); Tadashi Yonezaki, Newton, MA (US); Yun-Sun Kang, Cambridge, MA (US); Nathaniel Acheson, New York, NY (US)

(73) Assignee: TREMOR VIDEO, INC., New York, NY (US)

(21) Appl. No.: 14/150,343

(22) Filed: Jan. 8, 2014

Related U.S. Application Data
(60) Provisional application No. 61/750,148, filed on Jan. 8, 2013.

(51) Int. Cl. G06Q 30/02

(52) U.S. Cl. CPC G06Q 30/0242
USPC 705/14.41

(57) ABSTRACT

An apparatus includes a collection agent, an aggregation module, an analysis module, and a presentation module. The collection agent is operatively coupled to a data storage and is configured to (1) incrementally collect data associated with a presentation of media on a display of an electronic device, and (2) send a set of signals to store the incrementally collected data in the data storage. The aggregation module is configured to receive at least a portion of the incrementally collected data to define an aggregated data set. The analysis module is configured to analyze the aggregated data set to determine an effectiveness score associated with the presentation of the media. The presentation module is configured to (1) receive a signal associated with the effectiveness score, and (2) send a signal to an electronic device such that information associated with the effectiveness score is displayed on a display of the electronic device.

### CROSS-REFERENCE TO RELATED APPLICATIONS

This application claims priority to and the benefit of U.S. Provisional Patent Application Ser. No. 61/750,148 entitled “Methods and Apparatus for Providing Effectiveness Score of Advertisements,” filed Jan. 8, 2013, the disclosure of which is incorporated herein by reference in its entirety.

### BACKGROUND

Embodiments described herein relate generally to assessing the effectiveness of advertisements, and more particularly, to systems and methods for providing effectiveness scores of advertisement video streams.

Online advertising and Internet marketing for providing product and service promotions over the Internet is an increasing market. Some advertisements include, for example, presenting a video stream and/or picture on a display of a user device, playing an audio recording, and/or the like. In some instances, data associated with the presentation parameters and/or web site analytics is collected to determine, for example, an effectiveness of the presentation, which can influence the cost and/or revenue associated with the advertisement campaign. For example, some known systems and/or models calculate a cost of an advertisement based on empirical data associated with a web site or the advertisement such as the number of visitors to the web site presenting the advertisement, the number of impressions (e.g., the number of times the advertisement is presented to a viewer), the number of clicks (e.g., selection of a hyperlink or the like associated with the advertisement), and/or the like.

Some such systems for determining the cost and/or effectiveness of an advertisement, however, do not take into consideration the user's interaction with and/or impression of the advertisement. In an effort to collect data associated with a user's impression of the advertisement, in some instances, a survey can be presented to a user (e.g., a viewer of the advertisement) associated with the advertisement. Such surveys, however, are often inconvenient for the user and may not accurately reflect the user's sentiment. Moreover, some known systems do not automatically collect and/or aggregate data associated with the advertisement to determine a cumulative effectiveness of the advertisement, resulting in incomplete and/or inaccurate reflections of the advertisement's effectiveness.

Thus, a need exists for improved systems and methods for providing effectiveness score of advertisements by statistical analysis of the empirical data.

### SUMMARY

Systems and methods for providing effectiveness scores of advertisement video streams are described herein. In some embodiments, an apparatus includes a collection agent, an aggregation module, an analysis module, and a presentation module. The collection agent is operably coupled to a data storage and is configured to (1) incrementally collect data associated with a presentation of media on a display of an electronic device, and (2) send a set of signals indicative of instructions to store the incrementally collected data in the data storage. The aggregation module is operatively coupled to the data storage and is configured to receive at least a portion of the incrementally collected data to define an aggregated data set. The analysis module is operatively coupled to the aggregation module and is configured to analyze the aggregated data set to determine an effectiveness score associated with the presentation of the media on the display of the electronic device. The presentation module is operatively coupled to the analysis module and is configured to (1) receive a signal associated with the effectiveness score from the analysis module, and (2) send a signal to an electronic device that is indicative of an instruction to display information associated with the effectiveness score on a display of the electronic device.

### BRIEF DESCRIPTION OF THE DRAWINGS

FIG. 1 is a schematic illustration of a system for determining an effectiveness score of a presentation of media, according to an embodiment.

FIG. 2 is a schematic illustration of a host device included in the system of FIG. 1.

FIG. 3 is a flowchart of a process for calculating an effectiveness score, according to an embodiment.

FIG. 4 is a schematic illustration of a presentation of media on a display of a user device, according to an embodiment.

FIGS. 5 and 6 are schematic illustrations of a presentation of media on a display of a user device, according to another embodiment.

FIG. 7 is a flowchart illustrating a method of determining an effectiveness score of a presentation of media on a display of an electronic device, according to an embodiment.

### DETAILED DESCRIPTION

In some embodiments, an apparatus includes a collection agent, an aggregation module, an analysis module, and a presentation module. The collection agent is operably coupled to a data storage and is configured to (1) incrementally collect data associated with a presentation of media on a display of an electronic device, and (2) send a set of signals indicative of instructions to store the incrementally collected data in the data storage. The aggregation module is operatively coupled to the data storage and is configured to receive at least a portion of the incrementally collected data to define an aggregated data set. The analysis module is operatively coupled to the aggregation module and is configured to analyze the aggregated data set to determine an effectiveness score associated with the presentation of the media on the display of the electronic device. The presentation module is operatively coupled to the analysis module and is configured to (1) receive a signal associated with the effectiveness score from the analysis module, and (2) send a signal to an electronic device that is indicative of an instruction to display information associated with the effectiveness score on a display of the electronic device.

In some embodiments, a non-transitory processor-readable medium stores code representing instructions to be executed by a processor. The code includes code to cause the processor to receive, from a first electronic device and via a network, a first signal representing data associated with a first temporal portion of a single presentation of media on a display of the first electronic device. A second signal is received from the first electronic device and via the network that represents data associated with a second temporal portion of the single presentation of media on the display of the first electronic device. The code causes the processor to calculate an effectiveness score associated with the first temporal portion and the second temporal portion of the presentation of the media. The code causes the processor to send a signal indicative of an instruction to present, on a display of a second electronic device, data associated with the effectiveness score.

In some embodiments, a method includes receiving, at a host device, a signal representing data associated with a presentation of media on a display of a first electronic device at a first time during the presentation of the media. The method includes determining a first effectiveness score associated with the presentation of the media on the display of the first electronic device at the first time. A signal is received that represents data associated with the presentation of the media on the display of the first electronic device at a second time during the presentation of the media, after the first time. The method includes determining a second effectiveness score based on the first effectiveness score and the data associated with the presentation of the media on the display of the first electronic device at the second time. A signal is sent that is indicative of an instruction to present, on a display of a second electronic device, data associated with the first effectiveness score and the second effectiveness score.

As used in this specification, the singular forms “a,” “an” and “the” include plural referents unless the context clearly dictates otherwise. Thus, for example, the term “a video stream” is intended to mean a single video stream or a combination of video streams (e.g., video streams associated with an advertiser, a product, etc.).

As used herein, the term “module” refers to any assembly and/or set of operatively-coupled electrical components that can include, for example, a memory, a processor, electrical traces, optical connectors, software (executing in hardware), and/or the like. For example, a module executed in the processor can be any combination of hardware-based module (e.g., a field-programmable gate array (FPGA), an application specific integrated circuit (ASIC), a digital signal processor (DSP)) and/or software-based module (e.g., a module of computer code stored in memory and/or executed at the processor) capable of performing one or more specific functions associated with that module.

As used herein, the term “agent” generally refers to an assembly of a module or an assembly of multiple modules configured to perform and/or execute a set of processes, functions, instructions, etc. Thus, the terms “agent” and “module” can be used interchangeably herein unless explicitly expressed otherwise.

As used herein, the terms “factor,” “value,” “credit,” and “score” can be used interchangeably and generally refer to a classification (e.g., a numerical or alphabetic designation) resulting from an evaluation and/or calculation of data. For example, a presentation of media on a display of an electronic device can be associated with a 100% viewability factor if 100% of the media is presented and/or viewable on the display. Similarly stated, the presentation of media on the display of the electronic device can be associated with a viewability value, viewability credit, and/or a viewability score of 100% if substantially the entire presentation of media is viewable of the display of the electronic device. In some instances, a factor, value, credit, and/or score can be evaluated as a percentage. In other instances, a factor, value, credit, and/or score can be evaluated as a real number and/or real number approximation (e.g., a 100% viewability score can be represented and/or evaluated as “1.0,” a 50% viewability score can be represented and/or evaluated as “0.5,” a 35% viewability score can be represented and/or evaluated as “0.35.”

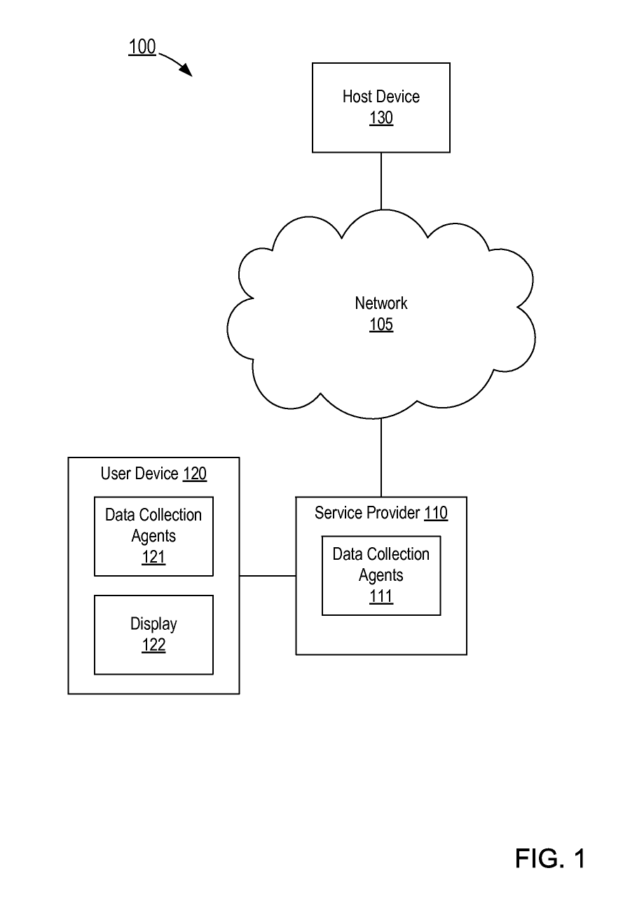

FIG. 1 is a schematic illustration of a computer network system 100 that can be used, for example, to calculate an effectiveness score of a presentation of an advertisement on a display of an electronic device, according to an embodiment. The computer network system 100 (also referred to herein as “system”) includes a service provider 110, a user device 120, and a host device 130 in communication via a network 105. As described in further detail herein, the host device 130 can be configured to send signals to and/or receive signals from the user device 120 and/or the service provider 110 representing data associated with a presentation of media (e.g., an advertisement or the like presented on or by the user device 120). In some embodiments, the signals sent and/or received over the network 105 can be associated with one or more attributes of the presentation of the media, as described in further detail herein. The host device 130 can be configured to aggregate and analyze data associated with the presentation of the media to define an effectiveness score associated therewith. Moreover, the host device 130 can be operable in presenting data associated with the effectiveness score (e.g., on a display of an electronic device). Although the system 100 is shown as including one service provider 110, one user device 120, and one host device 130, in other embodiments, the system 100 can include any number of service providers, user devices, and/or host devices. In some embodiments, the system 100 can include one host device in communication with multiple user devices and multiple service providers via the network 105.

The network 105 can be any suitable network or combination of networks configured to transmit data between two or more electronic devices. For example, the network 105 can be a local area network (LAN), a wide area network (WAN), a metropolitan area network (MAN), a worldwide interoperability for microwave access network (WiMAX), an intranet, the Internet, an optical fiber (or fiber optic)-based network, a virtual network (e.g., a virtual local area network (VLAN)), a cellular network, and/or any other suitable network or combination thereof. In some embodiments, the network 105 can include multiple networks of any type that are operably coupled via one or more network bridges, routers, switches, gateways, etc. For example, the network 105 can be a LAN or VLAN and the Internet. Moreover, any portion of the network 105 can be implemented as a wired network (e.g., an Ethernet connection, a digital subscription line (DSL) connection, a broadband coaxial connection, a fiber-optic connection, and/or the like) and/or wireless network (e.g., a wireless fidelity WiFi® connection, a wireless local area network WLAN, a cellular network connection, a Bluetooth® connection, and/or the like).

The service provider 110 included in the system 100 can be any suitable electronic device that can, for example, place the user device 120 in communication with the network 105 and/or that can provide content to be presented by the user device 120. For example, in some embodiments, the service provider 110 can be a network device such as a network server, an internet web server, a web host, and/or the like. Although not shown in FIG. 1, the service provider 110 can include at least a memory, a processor, and a network interface. The network interface can be, for example, a network interface card and/or the like that can include at least an Ethernet port, an optical fiber port, and/or a wireless radio (e.g., a wireless fidelity WiFi® radio, a Bluetooth® radio, etc.). The memory can be, for example, a random access memory (RAM), a memory buffer, a hard drive, a read-only memory (ROM), an erasable programmable read-only memory (EPROM), and/or the like. The processor can be any suitable processing device configured to run or execute a set of instructions, code, modules, etc. (e.g., stored in the memory). For example, the processor can be a general purpose processor, a central processing unit (CPU), an accelerated processing unit (APU), an Application Specific Integrated Circuit (ASIC), a network processor, a front end processor, a field programmable gate array (FPGA), and/or the like.

In some embodiments, the service provider 110 can be, for example, an internet service provider (ISP) that can be operable in placing the user device 120 in communication with the network 105. For example, the service provider 110 can include one or more data processing units such as an electronic switch, switch fabric, portion of a switch fabric, router, host device, data storage device, line card, backplane or the like used to process, transmit, and/or convey electrical and/or optical signals. In some embodiments, for example, the service provider 110 can include a data processing unit included in and/or forming a portion of a core switch fabric of a data center. In other embodiments, a data processing unit included in the service provider 110 can be an access switch located at an edge of a data center, or a host or peripheral device (e.g., a server) coupled to the access device.

In some instances, the user device 120 can receive and/or can access data and/or content stored by the service provider 110 via, for example, an internet web browser and/or any other suitable application and the Internet (e.g., the service provider 110 can be a web server or web host). In some instances, the service provider 110 can be configured to send data associated with a presentation of media to the user device 120. In some instances, the presentation of the media can be associated with an advertisement and/or the like, as described in further detail herein. Moreover, the service provider 110 can include, for example, one or more data collection agents 111 that can be configured to collect data associated with the presentation of the media, as described in further detail herein.

The user device 120 of the system 100 can be any suitable electronic device that can be in communication with the network 105 (e.g., operably coupled to the network 105). The user device 120 can be, for example, a personal computer (PC), a personal digital assistant (PDA), a smart phone, a laptop, a tablet PC, and/or the like. Although not shown in FIG. 1, the user device 120 can include at least a memory, a processor, and a network interface. The network interface can be, for example, a network interface card and/or the like that can include at least an Ethernet port and/or a wireless radio (e.g., a WiFi® radio, a Bluetooth® radio, etc.). The memory can be, for example, a random access memory (RAM), a memory buffer, a hard drive, a read-only memory (ROM), an erasable programmable read-only memory (EPROM), and/or the like. The processor can be any suitable processing device configured to run or execute a set of instructions or code. For example, the processor can be a general purpose processor, a central processing unit (CPU), an accelerated processing unit (APU), and Application Specific Integrated Circuit (ASIC), and/or the like. The processor can be configured to run or execute a set of instructions or code stored in the memory associated with using, for example, a PC application, a mobile application, an internet web browser, a cellular and/or wireless communication (via a network), and/or the like, as described in further detail herein.

As shown in FIG. 1, the user device 120 includes a display 122 and one or more data collection agents 121. The display 122 can provide at least a portion of a user interface for a software application (e.g., a mobile application, a PC application, an internet web browser, etc.) installed on the user device 120. In such embodiments, the display can be, for example, a cathode ray tube (CRT) monitor, a liquid crystal display (LCD) monitor, a light emitting diode (LED) monitor, and/or the like. In some embodiments, the display 122 can include a touch screen or the like. As described in further detail herein, the data collection agents 121 can be configured to collect data associated with a presentation of media on the display 122 of the user device 120. Although not shown in FIG. 1, the user device 120 can include other user interfaces that can include input and/or output devices such as a keyboard, a mouse, an audio device, a haptic device, and/or any other suitable output device.

As described above, the user device 120 can be in communication with the network 105. For example, in some instances, a user can cause the user device 120 to execute a set of instructions associated with an internet web browser (e.g., Internet Explorer, Chrome, Firefox, Safari, Dolphin, Opera, and/or the like) that can access a webpage or website hosted on or accessible via the service provider 110 over the network 105. In some embodiments, the user device 120 can support, for example, hypertext markup language (HTML) using JavaScript and/or the like. In some instances, an Internet page or website can be accessed by a user of the user device 120, via a web browser, by providing the web browser with a reference such as a uniform resource locator (URL), for example, of a webpage. For example, in some instances, a user of the user device 120 can access data and/or content stored at or by the service provider 110 via a URL designated for that service provider 110. In some instances, the user device 120 can include specialized software for accessing a web server (e.g., the service provider 110) other than a web browser, such as, for example, a specialized network-enabled application or program. In some instances, one or more portions of a website accessible via a web browser can be stored in, for example, the memory of the user device 120. Although not shown in FIG. 1, the user device 120 can include any other suitable user interfaces (e.g., other than a display) such as, for example, a keyboard, a mouse, various ports (e.g., a USB port), touch screen controls, audio components, video components, and/or the like.

The host device 130 of the system 100 can be any suitable electronic device that can send and/or receive data over the network 105 that is associated with a presentation of media on, for example, the display 122 of the user device 120 and based on the data, can define an effectiveness score associated with the presentation of the media. For example, the host device 130 can be a server and/or a combination of servers that can be centrally located or distributed at different locations. In other embodiments, any portion of the host device 130 can be performed by and/or included in the service provider 110 and/or the user device 120.

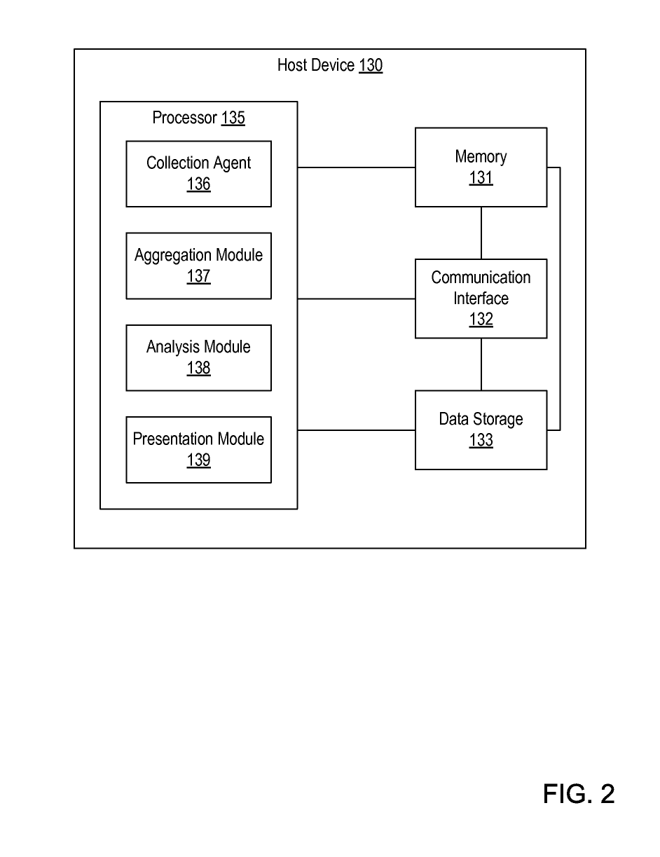

As shown in FIG. 2, the host device 130 includes a memory 131, a communication interface 132, a data storage 133, and a processor 135. Although not shown in FIGS. 1 and 2, the host device 130 can include any other suitable component such as, for example, one or more user interfaces (e.g., keyboard, mouse, display, haptic input and output, audio input and output, etc.). The memory 131 can be, for example, a random access memory (RAM), a memory buffer, a hard drive, a read-only memory (ROM), an erasable programmable read-only memory (EPROM), and/or the like. In some embodiments, the memory 131 can be configured to store, for example, one or more modules that can include instructions that can cause the processor 135 to perform one or more processes, functions, and/or the like, as described in further detail herein.

The communication interface 132 can be any suitable device that can communicate with the network 105. The communication interface 132 can include one or more wired and/or wireless interfaces, such as, for example, Ethernet interfaces, optical carrier (OC) interfaces, and/or asynchronous transfer mode (ATM) interfaces, digital subscription line (DSL) interfaces, broadband coaxial interfaces, and/or the like. In some embodiments, the communication interface 132 can be, for example, a network interface card and/or the like that can include at least an Ethernet port and/or a wireless radio (e.g., a WiFi ® radio, a Bluetooth® radio, etc.).

The data storage 133 can be, for example, a table, a repository, a relational database, an object-oriented database, an object-relational database, a structured query language (SQL) database, an extensible markup language (XML) database, and/or the like. In some embodiments, the data storage 133 can be configured to store data associated with a presentation of media (e.g., on the display 122 of the user device 120) and/or data associated with an effectiveness score related to the presentation of media. Although shown in FIG. 2 as being included in the host device 130 and distinct from the memory 131, in other embodiments, the data storage 133 can be included in the memory 131. In other embodiments, the data storage 133 can be operably coupled to the host device 130 (e.g., via the network 105). In such embodiments, the data storage 133 can be, for example, a network-attached storage (NAS) device.

The processor 135 can be any suitable processing device configured to run or execute a set of instructions or code such as, for example, a general purpose processor (GPU), a central processing unit (CPU), an accelerated processing unit (APU), an application specific integrated circuit (ASIC), a network processor, a front end processor, a field programmable gate array (FPGA), and/or the like. As such, the memory 131 can store instructions or code to cause the processor 135 to execute modules (and/or agents), processes, and/or functions associated with sending, receiving, aggregating, analyzing, and/or displaying data associated with presentation of media, for example, on the display 122 of the user device 120. As shown in FIG. 2, the processor 135 includes a collection agent(s) 136, an aggregation module 137, an analysis module 138, and a presentation module 139. Although the modules included in the processor 135 are shown as being distinct modules, in other embodiments, any of the processes and/or functions described herein can combined and/or executed in a single module. Conversely, any of the process and/or functions described herein can be split into, for example, sub-processes that can be performed in and/or executed by any suitable number of modules.

The collection agent 136 of the host device 130 is configured to receive and/or collect data associated with a presentation of media on the display 122 of the user device 120. For example, in some embodiments, the collection agent 136 can receive a signal (e.g., via the communication interface 132 and the network 105) from the data collection agent 111 of the service provider 110 and/or from the data collection agent 121 of the user device 120. In some embodiments, the collection agent 136 can be configured to collect and/or retrieve data that can be at least temporarily stored by the data collection agents 111 and/or 121. In some embodiments, the collection agent 136 can be configured to receive and/or retrieve data associated with the presentation of the media incrementally in substantially real-time and/or according to a predetermined time interval. For example, in some instances, the collection agents 121 of the user device 120 can be configured to collect data associated with the presentation of media at a predetermined time interval during the presentation of media such as every second, every ten seconds, every thirty seconds, every minute, etc. Thus, the collection agent 136 can receive and/or retrieve data from the collection agents 121 at substantially real-time and/or at a predetermined time interval during the presentation of the media.

In some instances, the collection agents 121 can be configured to collect data associated with the presentation of media at a predetermined time interval based on, for example, a completion percentage (e.g., every 10% of completion (10%, 20%, 30%, etc.), every 25% (25%, 50%, 75%, 100%), and/or the like). In some embodiments, the collection agents 121 can collect data at a predetermined time interval that is not uniform. For example, the collection agents 121 can collect data at 25% completion and 50% completion, and then at 60% completion, 70% completion, 80% completion, 90% completion, and 100% completion. In some instances, the collection agents 121 can send a signal to the collection agent 136 at the end of each predetermined time interval. In other instances, the collection agents 121 can send a signal to the collection agent 136 at substantially the end and/or completion of the presentation of media. Thus, the collection agent 136 can receive and/or retrieve data associated with the presentation of the media at any suitable interval during the presentation of the media.

In some instances, the presentation of media on the display 122 of the user device 120 can be, for example, a video stream associated with an advertisement presented on a web page. Thus, the data received by the collection agent 136 can be associated with one or more attributes relating to the video stream of the advertisement. For example, the data can be associated with, a viewability of a media player on the display 122 such as placement of the media player, percentage of the media player shown on the display 122, etc.; a media completion rate such as a percentage of the video stream that was played; an effective media size such as a size of the video stream relative to the media player; a media player size such as a size of the media player relative to the display 122 and/or the web page; an audio level of the video stream (e.g., muted, not muted, 60% of a maximum volume, etc.); and/or the like. Moreover, as described above, the collection agents 121 and/or the collection agent 136 can incrementally collect data associated with the video stream in substantially real-time and/or at a predetermined time interval. In other instances, the collection agents 121 and/or the collection agent 136 can collect data associated with the video stream when, for example, one or more attributes associated with the video stream is changed (e.g., the video stream is muted, the media player size is reduced, and/or the like).

Although described above as receiving and/or retrieving data from the collection agents 121 of the user device 120, in other instances, the collection agent 136 can be configured to receive and/or retrieve substantially the same data from the collection agents 111 of the service provider 110 in a substantially similar manner. In some instances, the collection agent 136 can be configured to send a signal to, for example, the data storage 133 to at least temporarily store the data associated with the presentation of the media received from the collection agents 121 of the user device 120 and/or the collection agents 111 of the service provider 110.

The aggregation module 137 of the host device 130 can be configured to aggregate data associated with a set of attributes related to a presentation of media on the display 122 of the user device 120 to define an aggregated data set. The aggregation module 137 can be configured to associate, tag, reference, and/or relate the set of attributes to the corresponding presentation of media. In some instances, the aggregation module 137 can be configured to aggregate data associated with the presentation of media and relate the data to a time period during the presentation of the media. For example, in some embodiments, the aggregation module 136 can define an aggregated data set including data associated with a first time during a presentation of media and data associated with a second time during the presentation of media (e.g., after the first time). In some instances, the aggregation module 137 can define an aggregated data set including, for example, data associated with a video stream currently presented (e.g., substantially real-time) on the display 122 of the user device 120 and including, for example, historical data associated with previous presentations of the video stream. The aggregation module 137 can be configured to send a signal to, for example, the data storage 133 to at least temporarily store the aggregated data set.

The analysis module 138 of the host device 130 can receive and/or retrieve data associated with the presentation of the media from the data storage 133, and can analyze the data using one or more statistical analysis methods (described in further detail herein) to define an effectiveness value associated with each attribute. In some instances, the analysis module 138 can send a signal associated with the effectiveness values to the aggregation module 137, which in turn, can aggregate the effectiveness values to define an effectiveness score associated with the presentation of media. In other instances, the analysis module 138 can be configured to analyze, for example, an aggregated data set defined by the aggregation module 137 to define an effectiveness value based on data associated with each attribute and then, analyze the effectiveness values to define an effectiveness score associated with the presentation of the media.

In some embodiments, the analysis module 138 can be configured to send a signal to the data storage 133 to at least temporarily store the effectiveness values associated with each attribute and/or the effectiveness scores associated with a presentation of media (e.g., an advertisement video stream). In some instances, the analysis module 138 can send a signal to the data storage 133 to associate the effectiveness values and/or scores with identifying information. For example, data associated with one or more effectiveness values and/or effectiveness scores can be associated with the user device 120, a group of user devices (e.g., electronic devices in a specific location), the service provider 110, a group of service providers (e.g., service providers of the same category such as news, entertainment, etc.), a specific advertisement, a specific product (e.g., having multiple associated advertisements), a manufacturer/producer of the advertised product, a specific advertising campaign, etc.

In some instances, the analysis module 138 can be configured to define an effectiveness score associated with a presentation of media at a first time and can be configured to update the effectiveness score based on data associated with the presentation of media at a second time, after the first time. For example, as described above, the collection agent 136 can incrementally receive and/or retrieve data associated with the presentation of media at and/or according to a predetermined time interval. In this manner, the analysis module 138 can define an effectiveness score associated with the presentation of the media at the first time and can update the effectiveness score based on data (e.g., received from the collection agent 136) associated with the presentation of media at the second time, after the first time and in accordance with the predetermined time interval. In some instances, the analysis module 138 can define an effectiveness score associated with a presentation of media in substantially real-time.

The presentation module 139 of the host device 130 can be configured to, for example, define a report, graph, presentation, chart, etc. representing data associated with an effectiveness score and/or attributes of the presentation of media on the display 122 of the user device. The report and/or the like can be in any suitable arrangement to present data to a user such as, for example, an administrator, an advertisement executive, a service provider administrator, a web page developer, etc. In some instances, the presentation module 139 can be configured to send a signal indicative of an instruction to present data associated with a score, report, and/or the like on a display of an electronic device (e.g., a computer, a laptop, a smart phone, etc.). Thus, the effectiveness of a presentation of media on the display 122 of the user device 120 can be determined based at least in part on a user's interaction with the presentation.

While shown and described above as being executed at a single host device, the modules and/or functions described above with respect to FIGS. 1 and 2 can be stored and/or executed at multiple host devices, user devices and/or service providers. Specifically, in such embodiments, the structure and function associated with the modules 136-139, the communication interface 132 and/or the data storage 133 can be distributed across multiple host devices, user devices (e.g., user device 120) and/or service providers (e.g., service provider 110). For example, the collection agent 136 and the aggregation module 137 can be executed at a first device and the analysis module 138 and the presentation module 139 can be executed at a second device. In other embodiments, the modules and/or functions described above with respect to FIGS. 1 and 2 can be stored and/or executed at a single user device and/or service provider.

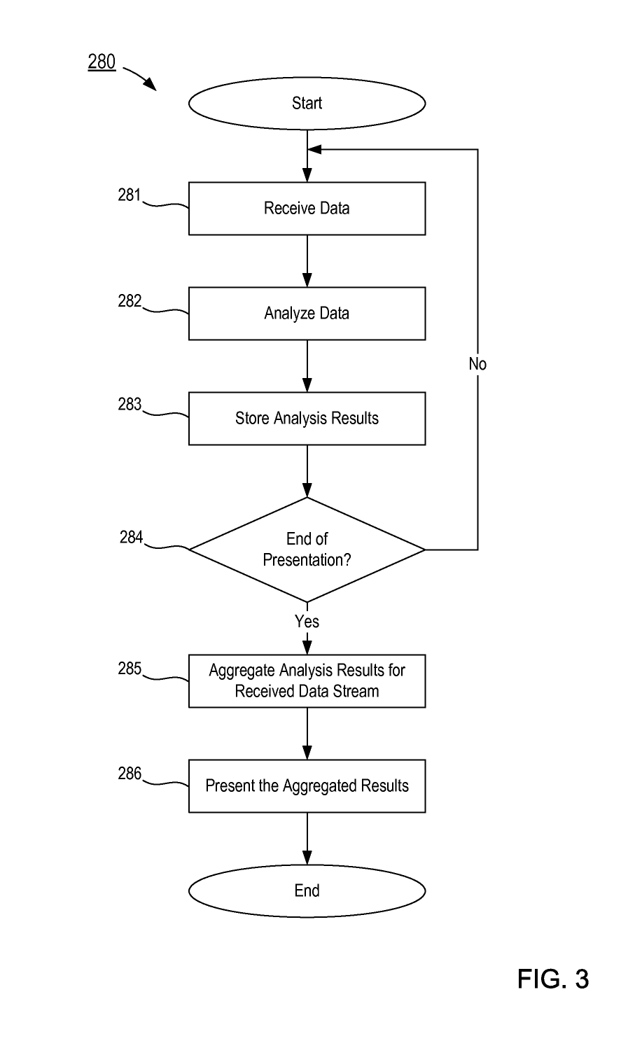

FIG. 3 is a flowchart of a process 280 for calculating an effectiveness score associated with a presentation of media on a display of an electronic device, according to an embodiment. Such an effectiveness score can be used, for example, to assist a purchaser of an advertisement in determining an effectiveness of the advertisement based at least in part on a user's interaction with the advertisement. For example, if an advertisement campaign is presented on a display of multiple electronic devices (e.g., millions of electronic devices), for instance, 10 million times (i.e., 10 million impressions), the effectiveness score associated with the advertisement campaign can help the advertisement purchaser determine how many of the 10 million impressions are quality impressions. As described in further detail herein, the advertisement purchaser can filter, group, and/or aggregate data associated with the effectiveness scores by publisher, agency, advertisement campaign, website, placements, etc.

As shown in FIG. 3, data associated with a presentation of media on a display of an electronic device is received, at 281. In some embodiments, data can be received, for example, at a collection agent and/or module of a host device such as the collection agent 136 of the host device 130 in FIGS. 1 and 2. Moreover, in such embodiments, the collection agent can receive the data from, for example, one or more data collection agents included in the user device and/or a service provider (e.g., the data collection agents 111 of the service provider 110 and/or the data collection agents 121 of the user device 120 in FIG. 1). In some embodiments, the collection agent and/or any other component included in the host device can store the data received from the collection agents in a data storage such as, for example, the data storage 133 in FIG. 2.

In some instances, the data can be associated with attributes relating to a viewability of the presentation of media of the display of the electronic device. In some instances, the presentation of media can be an advertisement video stream included in or on a web page (e.g., accessible and viewable via a web browser installed on the electronic device). For example, the data can be associated with attributes relating to a viewability of a media player on the display of the electronic device such as placement of the media player, percentage of the media player shown on the display, etc.; a media completion rate such as a percentage of the video stream that was played; an effective media size such as a size of the video stream relative to the media player; a media player size such as a size of the media player relative to the display 122 and/or the web page; an audio level of the video stream (e.g., muted, not muted, 60% of a maximum volume, etc.); and/or the like. In some embodiments, the collection agents can determine the size and the position of the video player on the display of the electronic device using a Video Player Ad Interface Definition (VPAID) tool and/or the like.

The data stored, for example in the data storage, is analyzed to determine an effectiveness score based on the stored data, at 282. For example, in some embodiments, a host device can include an analysis module such as the analysis module 138 of the host device 130 in FIG. 2. The analysis module can perform any suitable analysis of the data associated with the presentation of media to define one or more effectiveness scores and/or factors associated with a user's interaction with the presentation of media. For example, in some instances, a viewability factor (e.g., an effectiveness value associated with viewability) can be determined that is related to the viewability of the media (e.g., the video stream of the advertisement) on the display of the electronic device. By way of example, a video stream played at a center of the display can be associated with a viewability factor of 100%, while a video stream played at a location at or near the bottom of the display can be associated with a 50% viewability factor. Similarly, a full screen video player can be associated with a player size factor of 100%, while a player with a size of about one fourth of a size of the display can be associated with a player size factor of 25%. Moreover, a completed presentation of media (e.g., a completion of the video stream) can be associated with a completion rate factor of 100%, while a presentation of media that is stopped, for example, a third of the way through a total time of the presentation (e.g., a third of the total length of time of the video stream) can be associated with a completion rate factor of about 33%.

In some instances, the determined factors (e.g., effectiveness values) can be adjusted and/or updated based on the collected data (e.g., the analysis module or the like can be substantially adaptive to adjust the scores based on updated information and/or a subset of information included in the collected data). For example, if a video stream displayed at the bottom of the page is initially associated with a 50% viewability factor based on the placement of the media player, yet it is determined (e.g., through analysis of the collected data) that the video stream is associated with a 30% viewership among a group users of electronic devices (e.g., only 30% of the users viewed the video stream), the viewability factor for the bottom of the screen can be adjusted to 30%.

In some instances, effectiveness factors can be combined. For example, if a presentation of a video stream is displayed with complete viewability for half of the duration of the presentation video stream (i.e., 100% viewability for 50% of the video length) and half way through the advertisement the user scrolls, for example, downward on a web page such that only half of the video player is visible (50% viewability for 50% of the video length), the total viewability for the entire video can be defined as 75% (the average of 100% and 50%), while a video that is played completely with 100% viewability may be assigned a viewability of 100%. The analyzed data and/or the effective scores can be stored, for example, in the data storage, at 283.

In some instances, the effectiveness score is calculated incrementally in substantially real-time and/or at a predetermined time interval such that the effectiveness values associated with a presentation of media at a first time are updated with data associated with the presentation of media at a second time, after the first time. For example, in some instances, a data collection agent and/or the like can analyze a presentation of a video stream to determine whether the presentation of the video stream is actively playing, stopped, and/or completed, at 284. Thus, if the presentation of the video stream is actively playing (e.g., not stopped and not completed), the data collection agents can incrementally collect new data (e.g., in accordance with the predetermined time interval), and the process 280 of FIG. 3 can loop such that the collection agent and/or the like receives data, at 281.

When, for example, the data collection agents determine the presentation of the video stream is completed, the analyzed data (e.g., effectiveness scores and/or data associated therewith) defined by the analysis module is aggregated to define an aggregated data set, at 285. For example, an aggregation module such as the aggregation module 137 can aggregate data associated with the effectiveness scores or factors and can sort and/or associate the data with corresponding identifying information associated with the media. By way of example, the analysis module can aggregate the data and can associate portions of the data with corresponding information related to a product, a producer, a distribution agency, etc. Thus, an advertiser can determine an effectiveness of an advertisement campaign for a specific region, a specific publisher, a specific website, etc.

The aggregated data can be presented to, for example, one or more service providers, distribution agencies, manufacturers and/or producers, etc., at 286. For example, in some instances, a host device and/or the like can send a signal to any suitable electronic device that is indicative of an instruction to present at least a portion of the aggregated data on a display of the electronic device. In some instances, the aggregated data can be arranged and/or presented in the form of one or more reports, tables, curves, graphs, charts, text, etc. Thus, the by defining an effectiveness score based on, for example, a user's interaction with a presentation of media, the purchaser of the advertisement can plan future advertisements with attributes that can increase an effectiveness of the advertisement.

While shown in FIG. 3 as aggregating the data at the end of the presentation of the media, in other embodiments, an aggregation module and/or the like can aggregate the data associated with the effectiveness scores incrementally as the data is received. For example, after receiving an initial data set associated with an effectiveness score, data associated with the effectiveness score can be presented to a user. When subsequent data is received (e.g., in accordance with a predetermined time interval), the data can be analyzed and aggregated with the initial data set and data associated, for example, an updated effectiveness score can be presented. In some instances, the data can be aggregated, incrementally and substantially as the data is received and/or collected, with data from other effectiveness factors with similar characteristics (e.g., same website, same publisher, same advertisement campaign, etc.). In this manner, an advertisement purchaser can receive substantially real-time updates regarding the effectiveness of their advertisements.

In some instances, the effectiveness score for each presentation (i.e., impression) of an advertisement (e.g., the presentation of an advertisement to a user while viewing a web page on, for example, the display 122 of the user device 120) can be calculated separately. In some instances, a host device can aggregate data associated with video streams produced by a publisher, distributed by an agency, and/or the like to provide an effectiveness score for the publisher or the agency. In other instances, the host device can analyze the data to define one or more effectiveness scores associated with an advertisement and can aggregate the effectiveness scores for a product across multiple publishers or distribution agencies, etc. Moreover, the host device can be configured to store data associated with the presentation of the video stream and/or the effectiveness scores in a data storage (e.g., the data storage 133).

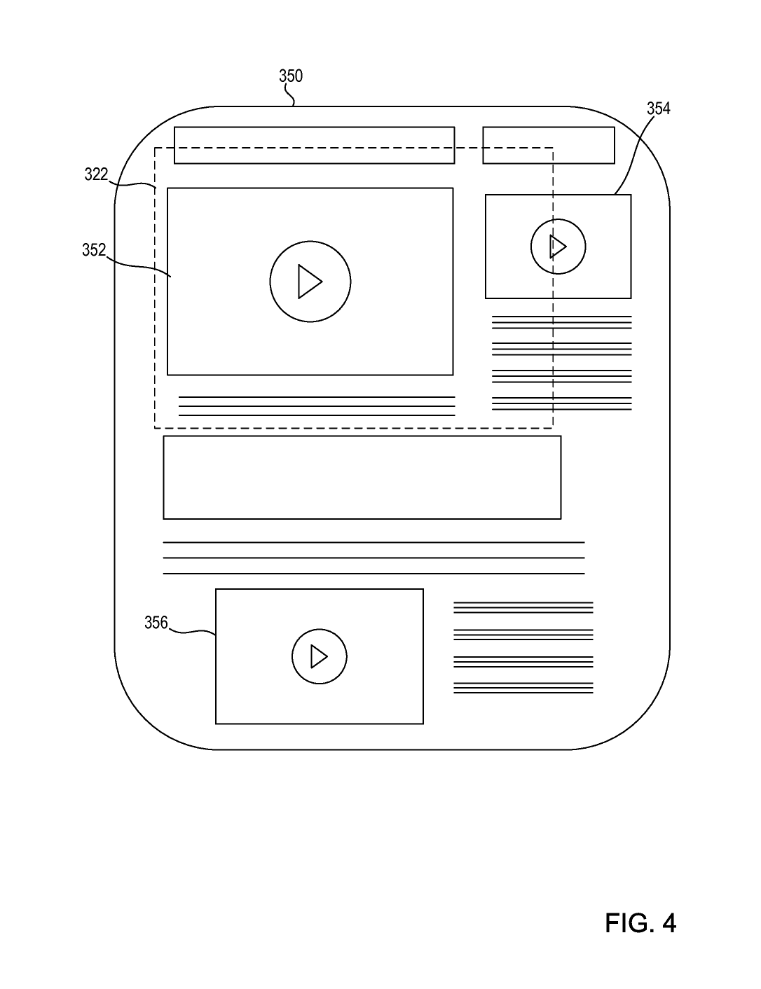

FIG. 4 is a schematic illustration of a display 322 of an electronic device (not shown) presenting, for example, a set of advertisement video streams, according to an embodiment. Although not shown in FIG. 4, the electronic device can be any suitable electronic device such as, for example, the user device 120 described above with reference to FIG. 1. Similarly, the display 322 can be any of suitable display such as described above with reference to the display 122 in FIG. 1. In some instances, the user can manipulate the electronic device such that an Internet web browser is represented on the display 322. Moreover, as described above, the user can input, for example a URL associated with a web site such that a web page 350 associated therewith is presented in the web browser and at least partially viewable on the display 322. As shown, the web page 350 can be substantially larger than the display 322. That is to say, the display 322 does not present the entire web page 350 as, for example, a single presentation; rather the user of the electronic device can manipulate the web browser (e.g., via a user input such as a mouse or keyboard, a touch screen, an ocular placement recognition interface, etc.) to scroll portions of the web page 350 into view of the display 322.

The electronic device having the display 322 can be in communication with a host device (not shown in FIG. 4) such as, for example, the host device 130 of FIGS. 1 and 2. In this manner, the electronic device can be configured to send signals to and/or receive signals from the host device that are associated with a presentation of one or more advertisement video streams. In some instances, the electronic device can be configured to incrementally send signals to the host device in substantially real-time and/or at a predetermined time interval during the presentation of the one or more advertisement video streams. Although not shown in FIG. 4, the host device can send signals to and/or receive signals from the electronic device and can be configured to analyze and aggregate data associated with the presentation of the one or more advertisement video streams to define, for example, an effectiveness score based on a set of attributes associated therewith. Moreover, the host device can define a report or the like based on data associated with the effectiveness score and can send a signal to any suitable electronic device to present the report, as described in detail above with reference to FIG. 3.

The web page 350 includes and/or presents a set of media players 352, 354, and 356 each configured to stream an advertisement video. The arrangement of the display 322 and the web page 350 shown in FIG. 4 is such that the media player 352 is completely viewable on or in the display 322, about half of the media player 354 is viewable on the display 322, and the media player 356 in not viewable on the display 322. Therefore, as described in detail above with reference to FIGS. 2 and 3, the advertisement video presented by the media player 352 can be associated with a viewability factor of 100%; the advertisement video presented by the media player 354 can be associated a viewability factor of 50%; and the advertisement video presented by the media player 356 can be associated with a viewability factor of 0%.

The user device (e.g., one or more collection agents) can collect and/or the host device can receive data associated with the advertisement videos in substantially real-time and/or according to a predetermined time interval, as described in detail above. In this manner, if a user of the electronic device scrolls the web page 350 relative to the display 322 to view, for example, a quarter of the video presented by the media player 356 (e.g., the top 25% of the media player 356), the viewability factor of the advertisement video presented by the media player 354 will be decreased from 50% to 0%; the viewability factor of the advertisement video presented by the media player 352 will be decreased from 100% to, for example, 25%; and viewability factor of the advertisement video presented by the media player 356 will be increased from 0% to 25%. Similarly, if the user scrolls the web page 350 to the right relative to the display 322 such that substantially the entire media player 354 is viewable on the display 322, the viewability factor of the advertisement video presented by the media player 352 will be decreased from 100% to, for example, 75%; the viewability factor of the advertisement video presented by the media player 354 will be increased from 50% to 100%; and the viewability factor of the advertisement video presented by the media player 356 will remain 0%.

In some instances, an effectiveness score associated with the advertisement videos presented in the media players 352, 354, and 356 can also be based on media player size and/or location relative to the web page 350. For example, in some instances, the advertisement video presented by the media player 352 can be associated with the largest media player size factor (e.g., the media player 352 is the largest); the advertisement video presented by the media player 356 can be associated with the second largest media player size factor (e.g., the media player 356 is the second largest); and the advertisement video presented by the media player 354 can be associated with the smallest media player factor (e.g., the media player 354 is the smallest). In some instances, the media player size factor can be based on a relative size of the media players 352, 354, and 356 (and/or relative to other media players not shown in FIG. 4). For example, the media player 352 can be associated with a media player size factor of 3, the media player 356 can be associated with a media player size factor of 2, and the media player 354 can be associated with a media player size factor of 1. In other instances, the media player size factor can be based on a size of the media players 352, 354, and 356 relative to the web page 350 and/or a predetermined range of sizes (e.g., not necessarily relative to each other). For example, in some embodiments, the size of the media player 352 can be included in or between a range of sizes associated with a 100% media player size factor; the media player 354 can be included in or between a range of sizes associated with a 50% media player size factor; and the media player 356 can be included in or between a range of sizes associated with a 30% media player size factor.

In a similar manner, the advertisement video presented by the media players 352, 354, and 356 can be associated with a location factor. The location factor can be based on a location of media players 352, 354, and 356 on the web page 350 relative to the display 322. For example, in some instances, the advertisement video presented by the media player 352 can be associated with the largest location factor (e.g., the media player 352 is located such the media player 352 is viewable on the display 322 upon visiting the web page 350); the advertisement video presented by the media player 354 can be associated with the second largest location factor (e.g., the media player 354 is located such that a portion of the media player 354 is viewable on the display 322 upon visiting the web page 350); and the advertisement video presented by the media player 356 can be associated with the smallest location factor (e.g., the media player 356 is not viewable on the display 322 upon visiting the web page 350 until a user scrolls the web page 350 relative to the display 322). In this manner, the host device (not shown in FIG. 4) can define an effectiveness score associated with the advertisement videos presented by the media players 352, 354, and 356 based on a set of attributes associated therewith.

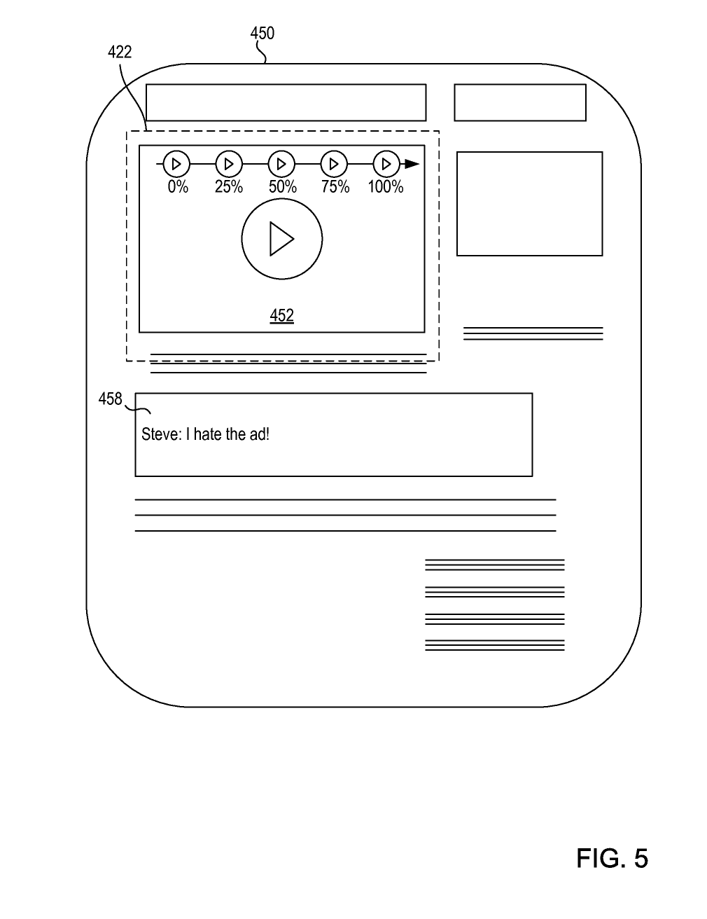

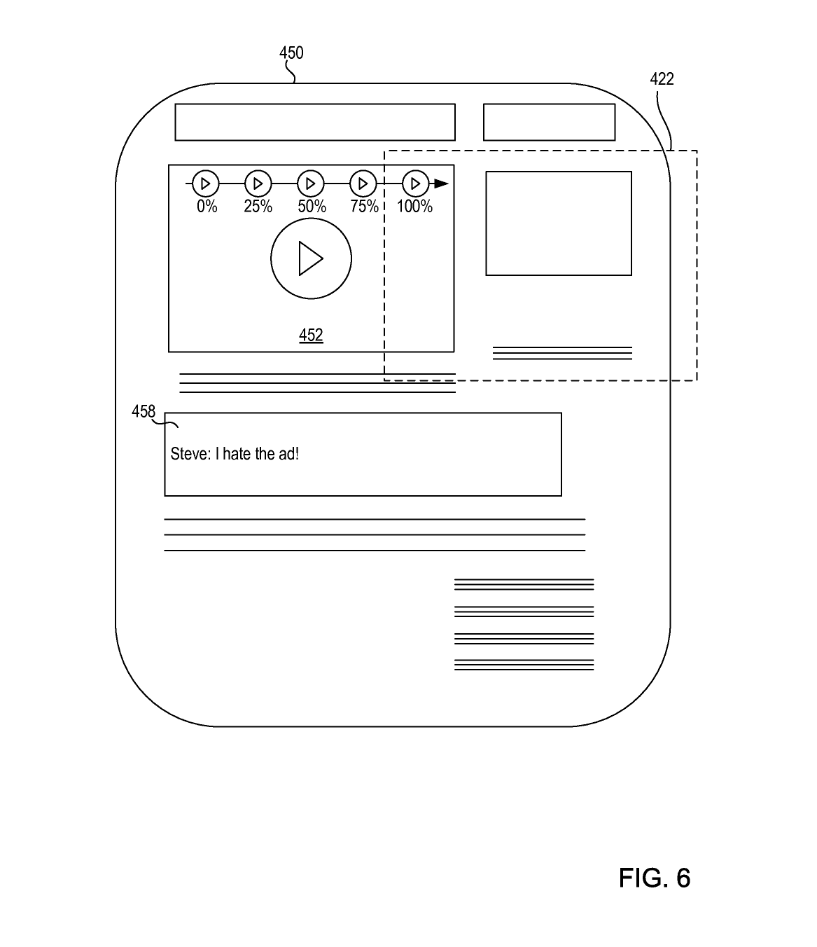

FIGS. 5 and 6 are schematic illustrations of a display 422 of an electronic device (not shown) presenting, for example, an advertisement video stream, according to an embodiment. Although not shown in FIGS. 5 and 6, the electronic device can be any suitable electronic device such as, for example, the user device 120 described above with reference to FIG. 1. Similarly, the display 422 can be any suitable display such as described above with reference to the display 122 in FIG. 1. In some instances, the user can manipulate the electronic device such that an Internet web browser is represented on the display 422. Moreover, as described above, the user can input, for example a URL associated with a web site such that a web page 450 associated therewith is presented in the web browser and at least partially viewable on the display 422. As shown, the web page 450 can be substantially larger than the display 422. That is to say, the display 422 does not present the entire web page 450 as, for example, a single presentation; rather the user of the electronic device can manipulate the web browser (e.g., via a user input such as a mouse or keyboard, a touch screen, an ocular placement recognition interface, etc.) to scroll portions of the web page 450 into view of the display 422.

The electronic device can be in communication with a host device (not shown in FIGS. 5 and 6) such as, for example, the host device 130 of FIGS. 1 and 2. In this manner, the electronic device can be configured to send signals to and/or receive signals from the host device that are associated with a presentation of an advertisement video stream. In some instances, the electronic device can be configured to incrementally send signals to the host device in substantially real-time and/or at a predetermined time interval during the presentation of the advertisement video stream. Although not shown in FIGS. 5 and 6, the host device can send signals to and/or receive signals from the electronic device and can be configured to analyze and aggregate data associated with the presentation of the advertisement video stream to define, for example, an effectiveness score based on a set of attributes associated therewith. Moreover, the host device can define a report or the like based on data associated with the effectiveness score and can send a signal to any suitable electronic device to present the report, as described in detail above with reference to FIG. 3.

FIG. 5 illustrates the website 450 presented, at least partially, on the display 422 of the electronic device during a first time interval (e.g., a first temporal portion) of a single presentation of an advertisement video stream in a media player 452. For example, in some instances, the first time interval can be associated with a first quartile of the total length of the advertisement video stream presented by the media player 452. As shown in FIG. 5, during the first time interval, the media player 452 is 100% viewable on display 422. FIG. 6 illustrates the website 450 during a second time interval (e.g., a second temporal portion), after the first time interval, of the presentation of the advertisement video stream in the media player 452. For example, in some instances, the second time interval can be associated with a last (e.g., fourth) quartile of the total length of the advertisement video stream presented by the media player 452. As shown in FIG. 6, during the second time interval, the website 450 can be scrolled relative to the display 422 such that the media player 452 is, for example, 20% on the display 422.

In some instances, the web page 450 can include a comment portion 458. In this manner, a user of the electronic device can evaluate the video stream presented by the media player 452 by posting (e.g., writing, typing, etc.) a comment in the comment portion 458. In some instances, the host device can analyze the comment (e.g., via an semantic analysis, keyword analysis, and/or the like) to define, for example, a comment factor and/or the like that can be used to calculate an effectiveness score for the advertisement video stream presented by the media player 452.

As shown below, Table 1 illustrates a transition of attributes with, for example, the media player 452 during the presentation of the advertisement video stream. The presentation of the advertisement video stream can be evaluated according to a predetermined time interval. More specifically, the electronic device can include a set of data collection agents and/or the host device can include a collection agent or the like that can incrementally receive data associated with the advertisement video stream and, in turn, the host device (e.g., an analysis module or the like) can analyze the incrementally received data. As shown in Table 1, the predetermined time interval can be, for example, a quarter of the total length of the advertisement video stream. In other words, the advertisement video stream is divided into quartiles.

As shown in FIGS. 5 and 6 a size of the media player 452 is unchanged during the presentation of the advertisement video stream. Moreover, in some instances, the size of the media player 452 can be included in a range of sizes that are associated with, for example, a “Medium” size designation, as shown in Table 1. In some instances, media players with a size in the range of “Medium” media player sizes can be associated with, for example, a 90% credit (e.g., a 90% player size factor). Although shown for example as receiving a 90% credit, in other embodiments, a medium media player size can be associated with any suitable credit, factor, and/or score (e.g., 40%, 60%, 75%, 80%, etc.). As described in detail above, in some instances, the media player size factor (e.g., “Player Credit” in Table 1) can be based on a size of the media players 452 relative to the web page 450 and/or the display 422. For example, in some embodiments, a media player with a size included in a large player size range can receive a 100% player credit, a media player with a size included in the medium player size range can receive the 90% player credit, a media player with a size included in a small player size range can receive a 75% player credit, a media player with a size included in a very small player size can receive a 50% player credit, etc. In some instances, the amount of the player credit and/or what constitutes a very small, small, medium or larger player size can be determined, for example, by a service provider, by a manufacturer and/or producer, by a distribution agency, and/or based on historical data or past analysis results (e.g., past effectiveness scores), or a combination thereof.

As described above with reference to FIGS. 5 and 6, the viewability of the media player 452 can be decreased from being 100% viewable during, for example, the first time period (e.g., the first quartile) to being 20% viewable during, for example, the second time period (e.g., the fourth quartile). As shown in Table 1, the viewability of the advertisement video stream presented by the media player 452 is 100% during the first quartile, 80% during the second quartile, 40% during the third quartile, and 20% during the fourth quartile. The viewability of the advertisement video stream presented by the media player 452 is associated with a viewability credit. For example, 100% viewability can be associated with a 100% viewability credit, 80% viewability can be associated a 50% viewability credit, and 40% viewability and 20% viewability can be associated with a 0% viewability credit. As described above, the viewability credit can be determined, for example, by a service provider, by a manufacturer and/or producer, by a distribution agency, and/or based on historical data or past analysis results (e.g., past effectiveness scores), or a combination thereof. In some embodiments, location data (e.g., x-y coordinate data) associated with an advertisement can be used to determine and/or estimate the viewability of the media player 452. In other embodiments, location data can be estimated and/or derived from a data set obtained through an independent panel of individuals. In still other embodiments, the media player can detect system properties, rendering properties and/or the like to determine and/or estimate the location data and/or at least a portion of the viewability credit.

TABLE 1

| | | | | VIEW- |
|---|---|---|---|---|
| VIDEO | PLAYER | PLAYER | VIDEO | ABILITY |
| QUARTILE | SIZE | CREDIT | VIEWABILITY | CREDIT |
| 1^{st} (25%) | Medium | 90% | 100% | 100% |
| 2^{nd} (50%) | Medium | 90% | 80% | 50% |
| 3^{rd} (75%) | Medium | 90% | 40% | 0% |
| 4^{th} (100%) | Medium | 90% | 20% | 0% |

As described above, a host device (e.g., the host device 130 of FIGS. 1 and 2) can be configured to define an effectiveness score for the advertisement video stream based, at least in part, on a set of attributes associated therewith. For example, in some instances, the host device can define an effectiveness score associated with the advertisement video stream presented by the media player 452 based, at least in part, on the player credit and the viewability credit shown in Table 1. More specifically, the host device can define an effectiveness score associated with the advertisement video stream presented in the media player 452 by analyzing data (e.g., incrementally received data) using, for example, Equation (1):

$$ES = P \frac{1}{n} {\sum }_{i = 1}^{n} ( {V}_{i} {C}_{i} ) \qquad ( 1 )$$

Wherein ES is the effectiveness score, P is the player credit associated with the player size, n is the number of data sets (e.g., the number of predetermined time intervals during a single presentation of the advertisement video stream, for example, the four quartiles in Table 1), i is the current data set, Vᵢ is the viewability value for the current data set i, and Cᵢ is a coefficient for adjustment of viewability credit based on the viewability.

For example, for the first quartile of the advertisement video stream in Table 1 the viewability value of Vᵢ is 100% and the value of Cᵢ is 1, thus VᵢCᵢ is 100%*1=100% (e.g., the viewability credit of the first quartile). For the second quartile of the video in Table 1, value of Vᵢ is 80% and the value of Cᵢ is 0.625, thus VᵢCᵢ is 80%*0.625=50% (e.g., the viewability credit of the second quartile. In this example, the value of Cᵢ is zero for the third and fourth quartiles, thus the viewability credit for the third quartile and the fourth quartile is 0%. As shown in Table 1, the player size is constant, thus the player credit P is 90% (or 0.9) for each quartile. The value of n is 4 (e.g., the four quartiles). Thus, Equation (1) can be evaluated as shown below in Equation (2):

$$ES = 0.9 \frac{( 100 \% + 50 \% + 0 \% + 0 \% )}{4} = 33.75 \% \qquad ( 2 )$$

Thus, the effectiveness score of the presentation of the advertisement video stream is calculated as 33.75%. In other words, the impression (e.g., the presentation to the user) of the advertisement video stream presented by the media player 452 was 33.75% effective. In some instances, the effectiveness score can be aggregated, for example, with scores for the other impressions on the same website, for the same publisher, within the same advertisement campaign, and/or the like. In some instances, the effectiveness score associated with the advertisement video stream can be presented to the ad purchaser (e.g., in a report, graph, etc. as described above) and, in some instances, the effectiveness score can influence future advertising decisions. In some instances, a player size can be used as a proxy (e.g., substitute) for viewability.

Although the effectiveness score is defined by Equation (1) above, in other instances, the effectiveness score can be defined based on any other suitable factors and/or attributes associated with the advertisement video stream. For example, in some instances, a host device can collect data (e.g., incrementally as described above) that is associated with a distance between a user of the electronic device and, for example, the display 422 during the presentation of the advertisement video stream. In some such instances, the user can provide an indication of the distance between the user and the display 422 during the presentation of the advertisement video stream. In some embodiments, the electronic device can include a device that can be configured to monitor and/or determine the proximity of the user to the display 422. For example, in some embodiments, the electronic device can include a camera (e.g., a web cam) that can determine the user's proximity to the display. In other embodiments, the electronic device can include, for example, a sonar device and/or the like. In some embodiments, the user can wear a device that communicates with the electronic device to determine and/or provide an indication of the distance between the user and the display 422.

In some instances and as described above, the location of the media player 452 relative to the display 422 and/or the web page 450 can be used in conjunction with the player credit and/or the viewability value or credit to calculate the effectiveness score. For example, in some instances, the calculation of the terms VᵢCᵢ can be modified to include a location credit and/or the like.

In other instances, any other suitable measurement(s) and/or data can be used to calculate the effectiveness score. For example, the volume level of the audio of the video stream, the size of display 422 (e.g., determined by receiving system information and/or information provided by a user), a frequency the video is viewed by the user, etc. In some instances, a Signal to Noise Ratio (SNR) can be used, wherein the signal S represents the audio volume of the presented video (e.g., output by a speaker associated with electronic device) and the noise N represents external sounds collected by a microphone associated with the electronic device. Such a SNR can determine, for example, the quality (e.g., strength and clarity) of the audio associated with the presented video that can be heard by a user of electronic.

In some embodiments, measurements used to calculate the effectiveness score can be based on a video format used by the advertisement, a communication protocol associated with the advertisement, and/or the like. For example, a first set of data can be used for video players supporting the VPAID protocol and a second set of data can be used for video players not supporting the VPAID protocol. More specifically, for example, the host device may receive cookie data and a publisher identifier for a Video Ad Serving Template (VAST) advertisement but not location data (e.g., x-y coordinate data) of the advertisement. The host device, however, may receive location data from a VPAID advertisement. Thus, in some embodiments, the location data can be used to calculate an effectiveness score for a VPAID advertisement but not an effectiveness score for a VAST advertisement.

In some embodiments, the host device can project and/or estimate measurements to be used to calculate the effectiveness score. For example, an advertisement not supporting the VPAID protocol and/or rendered within an iFrame may not provide as much data as an advertisement supporting the VPAID protocol. Accordingly, for a non-VPAID advertisement and/or an advertisement within an iFrame, the host device can estimate measurements not received from the video player. In some embodiments, data for an advertisement (e.g., a non-VPAID advertisement) can be estimated based on a similarity between data received for that advertisement and data received from other similar advertisements associated with additional data. Specifically, based on a first set of data received from an advertisement (e.g., a non-VPAID advertisement), the host device can identify one or more similar advertisements associated with additional data. The host device can estimate a second set of data associated with the advertisement based on the additional data associated with the similar advertisements. In such embodiments, a more complete data set can be estimated for the advertisement.

In other embodiments, data can be estimated and/or derived from a smaller data set obtained through an independent panel of individuals. For example, VAST advertisements and/or advertisements within iFrames may not provide location data (e.g., x-y coordinate data) and/or viewability information. Thus, in such an example, location data and/or viewability information of an advertisement can be estimated and/or derived for a VAST advertisement and/or an advertisement within an iFrame. More specifically, for example, if a panel identifies that 80% of advertisements rendered on a website (e.g., espn.com, cnn.com, etc.) are viewable, and a VAST advertisement request is received from that website, the host device can estimate the viewability to be 100% because the advertisement is likely to be viewable. In some embodiments, as the percentage of advertisements viewable on a website decreases, the estimated viewability can decrease. For example, if a panel identifies that 60% of advertisements rendered on a website are viewable, and a VAST ad request is received from that specific website, the host device can estimate the viewability to be 60% (or some other percentage calculated based on 60%). In such embodiments, the viewability can be estimated based on a function of the likely viewability of the advertisement.

As described above, the host device can analyze, calculate, and aggregate an effectiveness score associated with an advertisement video stream substantially in real-time and/or at predetermined time intervals during a single presentation of the advertisement video stream, based on one or more indicators associated therewith. In some instances, the host device can define an effectiveness score associated with each time interval. For example, the value of ES in Equation (1) can be calculated for every quartile of the advertisement video stream (see e.g., Table 1). For example, the value of ES after the first quartile (ES₁) the second quartile (ES₂), and the third quartile (ES₃) can be calculated as shown below in Equation (3), Equation (4), and Equation (5), respectively:

$$\begin{matrix}{ES}_{1} = 0.9 \frac{( 100 \% )}{1} = 90 \% & ( 3 ) \\ {ES}_{2} = 0.9 \frac{( 100 \% + 50 \% )}{2} = 67.5 \% & ( 4 ) \\ {ES}_{3} = 0.9 \frac{( 100 \% + 50 \% + 0 \% )}{3} = 45 \% & ( 5 )\end{matrix}$$

In such an example, the effectiveness score can be presented to an advertisement purchaser at each quartile. Similarly, such data sets can be aggregated, incrementally and as the data sets are received, with data sets from other presentations with similar characteristics (e.g., same website, same publisher, same advertisement campaign, etc.). In this manner, an advertisement purchaser can receive substantially real-time updates regarding the effectiveness of the advertisements.

In some instances, the predetermined time interval can be defined by, for example, a service provider and/or the like. For example, in the above example the granularity of the effectiveness score (ES) is set based on quartiles of the duration of the advertisement video stream (n=4 in Equation (1)). In some instances, sampling with at a greater frequency (e.g., a shorter predetermined time interval and a larger number n in Equation (1)) can provide, for example, more data associated with the effectiveness of the advertisement video stream. In some instances, the shorter predetermined time interval can, for example, provide a service provider and/or an advertisement purchaser with data associated with the most effective duration of an advertisement video stream and/or a point in the advertisement video stream at which users seem to lose interest.

In some instances, the host device can aggregate data associated with different advertisement video streams such as, for example, different completion rates for different video streams, when different users view a video stream for different time periods. In some instances, data associated with viewability, video location relative to the display, etc. may not be available. In such instances, the host device can estimate the effectiveness score based on any other available data associated with the advertisement video stream such as, for example, data indicating that the user viewed the website containing the video during presentation of the advertisement video stream on the website.

While shown and described above as incrementally calculating and storing an effectiveness score for predetermined time intervals of an advertisement, in other embodiments the host device can store, instead of or in addition to the effectiveness score, other values used to calculate the effectiveness score. For example, the host device can store, for each predetermined time interval, a video time period value (e.g., a video quartile value), a player size indicator, a player credit value, a video viewability value, a viewability credit value and/or the like. In some embodiments, the host device can store any suitable mathematical combination of values used to calculate the effectiveness score. Similarly, stated, in such embodiments the host device can store a value derived and/or calculated by an intermediate calculation. For example, the host device can store a numerator and a denominator (e.g., of equation (1)) for each predetermined time period of the advertisement.

While shown and described herein as calculating an effectiveness score for a video advertisement, in other embodiments an effectiveness score can be calculated for any other suitable type of advertisement. For example, an effectiveness score can be calculated for an audio advertisement, a banner advertisement, and/or the like. In calculating an effectiveness score for an audio advertisement, for example, a host device such as the host device 130 can analyze the percent of the audio played, a volume at which the audio was played, and/or the like. In calculating an effectiveness score for a banner advertisement, the host device can analyze the position of the banner advertisement on the display screen, the size of the banner advertisement, the activity performed by the user within the banner advertisement (e.g., mouse over, clicks, etc.), the percent of the banner advertisement viewable by the user, the duration that the banner advertisement is displayed on the display screen, etc.

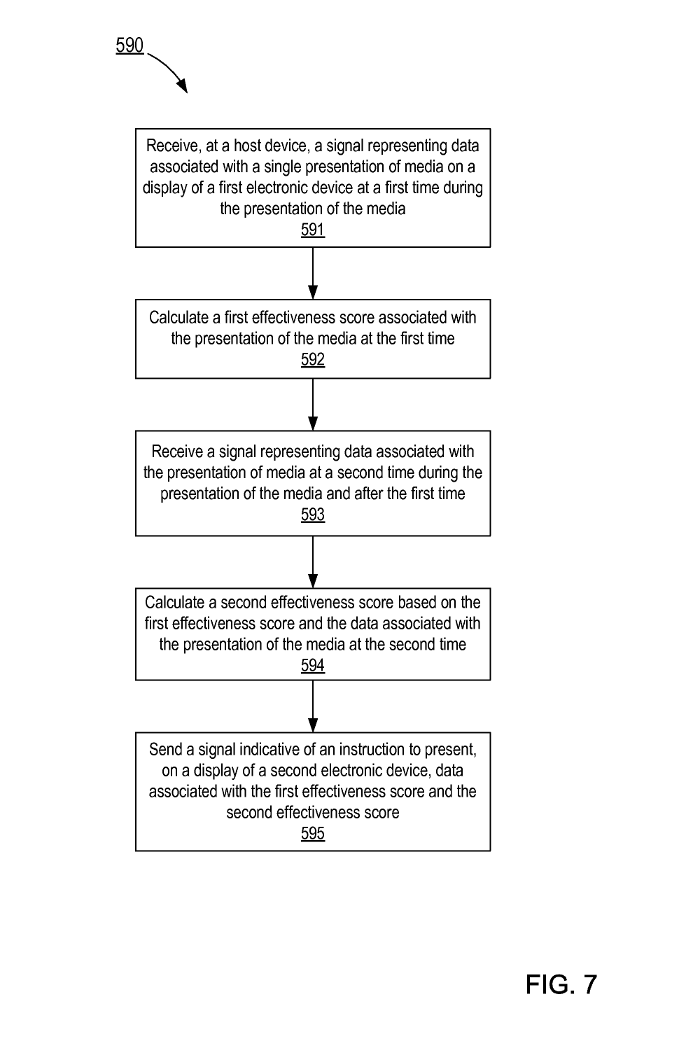

FIG. 7 is a flowchart illustrating a method 590 of determining an effectiveness score of a presentation of media on a display of an electronic device, according to an embodiment. The method 590 includes receiving, at a host device, a signal representing data associated with a single presentation of media (on a display of a first electronic device at a first time during the presentation of the media, at 591. In some embodiments, the first electronic device can be substantially similar to the user device 120 of FIG. 1 and the host device can be substantially similar to the host device 130 of FIGS. 1 and 2. As such, the first electronic device and the host device can be in communication via a network such as, for example, the network 105 of FIG. 1.

As described in detail above, in some instances, a user of the first electronic device can engage the first electronic device such that an Internet web browser is presented on the display of the first electronic device. In some instances, the user can input (e.g., via a keyboard, mouse, touch screen, voice command, etc.) a URL address associated with an Internet web site such that the web site and/or a web page is presented on the display of the first electronic device. In some instances, the web page can include, for example, a media player that can be configured to present the media to the user of the first electronic device. In some instances, the presentation of the media can be, for example, a presentation of an advertisement video stream and/or the like. In this manner, the single presentation of media can be one presentation of substantially the entire advertisement video stream (and/or or audio stream) or one presentation of a portion of the advertisement video stream.

In some embodiments, the first electronic device, the host device, and/or a service provider (e.g., an Internet web host and/or the like) can include, for example, data collection agents that can be configured to collect data associated with the presentation of the media. In some instances, the data collection agents of the first electronic device and/or of the service provider can send the signal representing data associated with the presentation of the media to the host device. In other instances, the host device can collect data associated with the presentation of the media. Thus, the host device can receive the signal representing data associated with the presentation of media on the display of the first electronic device at the first time during the presentation. In some instances, the first time can be, for example, an initial time associated with the start of the presentation of the media (e.g., the start of an advertisement video stream). In other instances, the first time during the presentation of the media can be, for example, after a predetermined time interval.

A first effectiveness score associated with the presentation of the media at the first time is calculated and/or determined, at 592. More specifically, the host device can include one or more modules configured to analyze and/or aggregate the data associated with the presentation of the media at the first time to define an effectiveness score associated with the presentation of the media at the first time. For example, in some embodiments, the host device can include an analysis module and/or an aggregation module such as, for example, the analysis module 138 and/or the aggregation module 137, respectively, shown in FIG. 2. In some instances, the host device can determine the effectiveness score based at least in part on a set of attributes associated with the presentation of the media. As described in detail above, the attributes can include, for example, a viewability of a media player on the display of the first electronic device such as placement of the media player, percentage of the media player shown on the display, etc.; a media completion rate such as a percentage of the video stream that was played; an effective media size such as a size of the video stream relative to the media player; a media player size such as a size of the media player relative to the display and/or the web page; an audio level of the video stream (e.g., muted, not muted, 60% of a maximum volume, etc.); a proximity of the user to, for example, the display of the first electronic device, and/or the like. In this manner, the host device can be configured to analyze the data associated with the attributes of the presentation of the media to determine the effectiveness score. In some instances, the host device can determine the effectiveness score of the presentation of the media at the first time based on, for example, Equation (1) described above with reference to FIGS. 5 and 6 and Table 1.

With the first effectiveness score calculated, a signal is received that represents data associated with the presentation of the media at a second time during the presentation of the media and after the first time, at 593. For example, the host device can receive the data from, for example, the data collection agents included in the first electronic device and/or the service provider. In some instances, the second time can be after a predetermined time interval (e.g., a quarter of the total duration of the presentation of media, as described with reference to Table 1). Thus, the host device can incrementally receive data associated with the presentation of the media, for example, according to the predetermined time interval. In other instances, the second time can be associated with a change in at least one attribute associated with the presentation of the media. For example, in some instances, the media can be 100% viewable on the display at the first time and during the presentation of the media, the user can, for example, scroll the web page relative to the display such that the media viewability of the media is reduced (e.g., from 100% to 50%). In such instances, the second time can be associated with the change in the viewability of the media.

A second effectiveness score associated with the presentation of the media at the second time is calculated and/or determined, at 594. In some instances, the host device can determine an effectiveness score associated with the presentation of the media at the second time in a substantially similar manner as described above with reference to the first effectiveness score. In some instances, the host device can aggregate the first effectiveness score and the effectiveness score associated with the presentation of the media at the second time to define the second effectiveness score. In other instances, the second effectiveness score can be based on data received after the first time (i.e., not aggregated with the first effectiveness score). In this manner, the first effectiveness score and the second effectiveness score can be compared and/or evaluated to, for example, determine what time period during the presentation of media is most effective.

With the second effectiveness score calculated, a signal is sent that is indicative of an instruction to present, on a display of a second electronic device, data associated with the first effectiveness score and the second effectiveness score, at 595. For example, in some embodiments, the second electronic device (e.g., a personal computer, a laptop, a tablet, a smart phone, etc.) can be associated with a user such as an administrator, a service provider, an advertisement purchaser, a distribution agency, and advertisement agency, etc. Thus, the user of the second electronic device can determine an effectiveness of the presentation of the media (e.g., the advertisement video stream) based on, for example, a user's interaction with the presentation of the media.

Some embodiments described herein relate to a computer storage product with a non-transitory computer-readable medium (also can be referred to as a non-transitory processor-readable medium) having instructions or computer code thereon for performing various computer-implemented operations. The computer-readable medium (or processor-readable medium) is non-transitory in the sense that it does not include transitory propagating signals per se (e.g., a propagating electromagnetic wave carrying information on a transmission medium such as space or a cable). The media and computer code (also can be referred to as code) may be those designed and constructed for the specific purpose or purposes. Examples of non-transitory computer-readable media include, but are not limited to, magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as Application-Specific Integrated Circuits (ASICs), Programmable Logic Devices (PLDs), Read-Only Memory (ROM) and Random-Access Memory (RAM) devices. Other embodiments described herein relate to a computer program product, which can include, for example, the instructions and/or computer code discussed herein.

Some embodiments and/or methods described herein can be performed by software (executed on hardware), hardware, or a combination thereof. Hardware modules may include, for example, a general-purpose processor, a field programmable gate array (FPGA), and/or an application specific integrated circuit (ASIC). Software modules (executed on hardware) can be expressed in a variety of software languages (e.g., computer code), including C, C++, Java™, Ruby, Visual Basic™, and/or other object-oriented, procedural, or other programming language and development tools. Examples of computer code include, but are not limited to, micro-code or micro-instructions, machine instructions, such as produced by a compiler, code used to produce a web service, and files containing higher-level instructions that are executed by a computer using an interpreter. Additional examples of computer code include, but are not limited to, control signals, encrypted code, and compressed code.

While various embodiments have been described above, it should be understood that they have been presented by way of example only, and not limitation. Where schematics and/or embodiments described above indicate certain components arranged in certain orientations or positions, the arrangement of components may be modified. While the embodiments have been particularly shown and described, it will be understood that various changes in form and details may be made. Although various embodiments have been described as having particular features and/or combinations of components, other embodiments are possible having a combination of any features and/or components from any of embodiments as discussed above.

Where methods and/or events described above indicate certain events and/or procedures occurring in certain order, the ordering of certain events and/or procedures may be modified. Additionally, certain of the events may be performed concurrently in a parallel process when possible, as well as performed sequentially as described above.

What is claimed:

1. An apparatus, comprising:
a collection agent implemented in at least one of a memory or a processing device, the collection agent configured to be operatively coupled to a data storage, the collection agent configured to (1) incrementally collect data associated with a single presentation of media on a display of an electronic device and (2) send a plurality of signals indicative of instructions to store the incrementally collected data in the data storage;
an aggregation module configured to be operatively coupled to the data storage, the aggregation module configured to receive at least a portion of the incrementally collected data to define an aggregated data set;
an analysis module operatively coupled to the aggregation module, the analysis module configured to calculate, based on the aggregated data set, an effectiveness score associated with the presentation of the media on the display of the electronic device; and
a presentation module operatively coupled to the analysis module, the presentation module configured to (1) receive a signal associated with the effectiveness score from the analysis module and (2) send a signal to an electronic device, the signal sent to the electronic device being indicative of an instruction to display information associated with the effectiveness score on a display of the electronic device.

2. The apparatus of claim 1, wherein the media on the display of the electronic device is an advertisement viewable on a web site.

3. The apparatus of claim 1, wherein the data associated with the presentation of the media on the display of the electronic device represents an attribute that is at least one of a viewability of the media, a media completion rate, an effective media size, a media player size, or an audio level of the media.

4. The apparatus of claim 1, wherein the effectiveness score is a first effectiveness score and the aggregated data set is a first aggregated data set, the first aggregated data set being associated with the presentation of the media on the display of the electronic device at a first time, the aggregation module configured to define a second aggregated data set, the second aggregated data set being associated with the presentation of the media on the display of the electronic device at a second time, after the first time,
the analysis module configured to calculate, based on the second aggregated data set, a second effectiveness score associated with the presentation of the media on the display of the electronic device at the second time.

5. The apparatus of claim 1, wherein the effectiveness score is a first effectiveness score and the aggregated data set is a first aggregated data set, the first aggregated data set being associated with the presentation of the media on the display of the electronic device at a first time, the aggregation module configured to define a second aggregated data set, the second aggregated data set being associated with the presentation of the media on the display of the electronic device at a second time, after the first time,
the analysis module configured to calculate, based on the second aggregated data set, a second effectiveness score based on the first effectiveness score and the presentation of the media on the display of the electronic device at the second time.

6. The apparatus of claim 1, wherein the collection agent incrementally collects the data during a time period in which a web site is presented on the display of the electronic device.

7. The apparatus of claim 1, wherein the collection agent incrementally collects the data according to a predetermined time interval.

8. A non-transitory processor-readable medium storing code representing instructions to be executed by a processor, the code comprising code to cause the processor to:
receive, from a first electronic device and via a network, a first signal, the first signal representing data associated with a first temporal portion of a single presentation of media on a display of the first electronic device;
receive, from the first electronic device and via the network, a second signal, the second signal representing data associated with a second temporal portion of the single presentation of media on the display of the first electronic device;
calculate, based on the first signal and the second signal, an effectiveness score, the effectiveness score being associated with the first temporal portion and the second temporal portion; and
send a signal indicative of an instruction to present, on a display of a second electronic device, data associated with the effectiveness score.

9. The non-transitory processor-readable medium of claim 8, wherein the single presentation of the media on the display of the first electronic device is an advertisement viewable on a web site.

10. The non-transitory processor-readable medium of claim 8, wherein a duration of the first temporal portion is substantially equal to a duration of the second temporal portion.

11. The non-transitory processor-readable medium of claim 8, wherein a duration of the first temporal portion and a duration of the second temporal portion are associated with a predetermined time interval.

12. The non-transitory processor-readable medium of claim 8, wherein the effectiveness score is a first effectiveness score, the code further comprising code to cause the processor to:
calculate, based on the first signal but not the second signal, a second effectiveness score, the second effectiveness score associated with the first temporal portion but not the second temporal portion.

13. The non-transitory processor-readable medium of claim 8, wherein the data associated with the first temporal portion of the single presentation of the media on the display of the electronic device represents an attribute that is at least one of a viewability of the media, a media completion rate, an effective media size, a media player size, or an audio level of the media.

14. A method, comprising:
receiving, at a host device, a signal representing data associated with a single presentation of media on a display of a first electronic device at a first time during the presentation of the media;
calculating a first effectiveness score associated with the presentation of the media on the display of the first electronic device at the first time;
receiving a signal representing data associated with the presentation of the media on the display of the first electronic device at a second time during the presentation of the media and after the first time;
calculating a second effectiveness score based on the first effectiveness score and the data associated with the presentation of the media on the display of the first electronic device at the second time; and
sending a signal indicative of an instruction to present, on a display of a second electronic device, data associated with the first effectiveness score and the second effectiveness score.

15. The method of claim 14, wherein the presentation of media on the display of the electronic device is an advertisement viewable on a web site.

16. The method of claim 14, wherein the data associated with the presentation of the media on the display of the electronic device represents an attribute that is at least one of a viewability of the media, a media completion rate, an effective media size, a media player size, or an audio level of the media.

17. The method of claim 14, further comprising:
sending a signal indicative of an instruction to present, on the display of the second electronic device, data associated with the first effectiveness score prior to the receiving the signal representing data associated with the presentation of media on the display of the first electronic device at the second time.

18. The method of claim 14, wherein the first time and the second time are separated by a predetermined time interval.

19. The method of claim 14, further comprising:
receiving a signal representing data associated with the presentation of the media on the display of the first electronic device at a third time, after the second time;
calculating a third effectiveness score based on the second effectiveness score and the data associated with the presentation of the media on the display of the first electronic device at the third time; and
sending a signal indicative of an instruction to present, on the display of the second electronic device, data associated with the third effectiveness score.
